(19) United States
(12) Patent Application Publication
(10) Pub. No.: US 2025/0055182 A1
(43) Pub. Date: Feb. 13, 2025

(54) UWB ANTENNA

(71) Applicant: LG INNOTEK CO., LTD., Seoul (KR)

(72) Inventor: Youn Ung JEONG, Seoul (KR)

(73) Assignee: LG INNOTEK CO., LTD., Seoul (KR)

(21) Appl. No.: 18/717,533

(22) PCT Filed: Dec. 8, 2022
(86) PCT No.: PCT/KR2022/019884

§ 371 Date: Jun. 7, 2024

(30) Foreign Application Priority Data
Dec. 8, 2021 (KR) 10-2021-0174452

(51) Int. Cl. H01Q 1/38; H01Q 5/25

(52) U.S. Cl. CPC H01Q 1/38; H01Q 5/25

(57) ABSTRACT

The present invention relates to an antenna, more particularly to a UWB antenna with wide bandwidth and adjustable resonant length; the antenna may include a semicircular plate portion and a plurality of adjustment pattern portions extending from the ends of the semicircular plate portion.

### TECHNICAL FIELD

The present invention relates to an ultra-wideband (UWB) antenna with a wide bandwidth and adjustable resonant length.

### BACKGROUND ART

The UWB system is a wireless technology capable of high-speed information transmission, achieving several hundred Mbps within a short range of up to 10 meters, utilizing ultra-low output power to avoid interference with existing wireless operations, and operating in frequency bands exceeding 500 MHZ, thus spreading the signal across a broad bandwidth for efficient transmission of large amounts of information.

There are various types of UWB antennas, including log-periodic antennas, Vivaldi antennas, discone antennas, double-ridged horn antennas, and bow-tie antennas. While these UWB antennas offer wideband capabilities, their bulky and intricate structures pose challenges for cost-effective mass production.

Numerous research efforts are underway to address these limitations, but a definitive solution remains elusive.

### DISCLOSURE

### Technical Problem

### Technical Solution

According to an embodiment, an antenna may include a semicircular plate portion; and a plurality of adjustment pattern portions extending from ends of the semicircular plate portion.

According to an embodiment, the antenna module may further include a coplanar waveguide (CPW) line extending from at least part of the semicircular plate portion, perpendicular to a straight line of the semicircular plate portion.

According to an embodiment, the plurality of adjustment pattern portions may extend from both ends of a straight line of the semicircular plate portion with a constant width and the same length.

According to an embodiment, the semicircular plate portion may include a groove extending from the center of the semicircular plate portion, perpendicular to the straight line of the semicircular plate portion.

According to an embodiment, the plurality of adjustment pattern portions may extend perpendicular to the straight line of the semicircular plate portion, the CPW line may be at least partly arranged in at least part between the plurality of adjustment pattern portions, and at least parts of the plurality of adjustment pattern portions and the CPW line may be parallel.

According to an embodiment, an antenna module may include a semicircular plate portion; and a plurality of adjustment pattern portions extending from ends of the semicircular plate portion.

According to an embodiment, the antenna module may further include a coplanar waveguide (CPW) extending from at least part of the semicircular plate portion, perpendicular to a straight line of the semicircular plate portion.

### Advantageous Effects

### DESCRIPTION OF DRAWINGS

FIG. 1 is a diagram illustrating the configuration of an antenna according to an embodiment;

FIG. 2 is a graph representing the bandwidth of the CPW line according to an embodiment;

FIG. 3 is a graph representing the resonance variation of an antenna according to an embodiment;

FIG. 4 is a graph illustrating the resonance characteristics of an antenna according to an embodiment; and

FIG. 5 is a diagram illustrating an antenna module according to an embodiment.

### MODE FOR INVENTION

Various changes may be made to the present invention, and specific embodiments will be illustrated in the drawings and described in detail. However, such an embodiment is not intended to limit the invention and it should be understood that the embodiment include all changes, equivalents, and substitutes within the spirit and scope of the invention.

Terms including an ordinal number such as “second” and “first” can be used to describe various components without limiting the components. The terms are used only for distinguishing one component from another component. For example, a second component may be referred to as a first component and, similarly, the first component may be referred to as the second component, without departing from the scope of the present invention. The term and/or includes a combination of a plurality of related items enumerated or any of a plurality of related items enumerated.

It will be understood that when a component is referred to as being “connected to” or “coupled to” another component, it can be directly connected or coupled to the other component or intervening component may be present. In contrast, when a component is referred to as being “directly connected to” or “directly coupled to” another component, there are no intervening component present.

The terminology used herein is for the purpose of describing particular embodiments only and is not intended to be limiting of the invention. As used herein, the singular forms are intended to include the plural forms as well, unless the context clearly indicates otherwise. It will be further understood that the terms “comprises” or “has,” when used in this specification, specify the presence of a stated feature, number, step, operation, component, element, or a combination thereof, but they do not preclude the presence or addition of one or more other features, numbers, steps, operations, components, elements, or combinations thereof.

Unless otherwise defined herein, all terms including technical or scientific terms used herein have the same meanings as commonly understood by those skilled in the art to which the present invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein.

Hereinafter, descriptions are made with reference to the accompanying drawings in which the same reference numbers are assigned to refer to the same or like components and redundant description thereof is omitted.

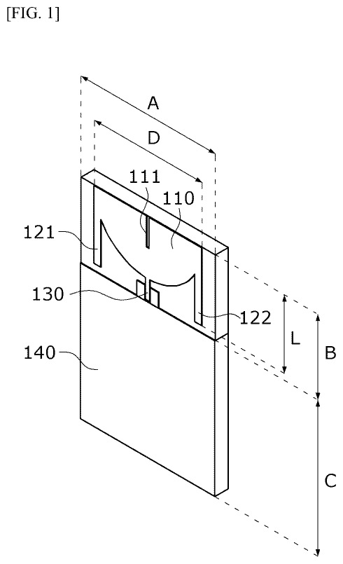

FIG. 1 is a diagram illustrating the configuration of an antenna according to an embodiment.

The antenna may include a semicircular plate portion 110, a plurality of adjustment pattern portions 121 and 122, a coplanar waveguide (CPW) line 130, and a UWB chip/component/circuit 140.

According to the embodiment, the antenna may include a semicircular plate portion 110 and a plurality of adjustment pattern portions 121 and 122 extending from the end of the semi-circular plate portion 110.

According to an embodiment, at least one of the components constituting the antenna may have a thickness of 18 microns, and may also have a thickness of about IT of an FR4 substrate. At least one of the components constituting the antenna may include at least partly the material of a PCB substrate. At least one of the components constituting the antenna may include a metal material.

The semicircular plate portion 110 may be in the form of a semicircular plate. The plurality of adjustment pattern portions 121 and 122 may be in the form of wings extending from the semicircular plate portion 110. The plurality of adjustment pattern portions 121 and 122, including adjustment pattern portion 121 and adjustment pattern portion 122, may be arranged symmetrically to each other and may have identical lengths and widths.

According to an embodiment, the antenna may further include a CPW line 130 extending from at least part of the semicircular plate portion, perpendicular to a straight line of the semicircular plate portion 110.

The CPW line 130 may be connected to the UWB chip/component/circuit 140 and may be connected to the ground (GND).

At least some of the semicircular plate portion 110, the plurality of adjustment pattern portions 121 and 122, the CPW line 130, and the UWB chip/component/circuit 140 may be arranged on the same plane. The plurality of adjustment pattern portions 121 and 122 and the CPW line 130 can extend towards the UWB chip/component/circuit 140.

According to an embodiment, the plurality of adjustment pattern portions 121 and 122 may extend from both ends of the straight line of the semicircular plate portion 110 with a constant width and the same length.

The width of the plurality of adjustment pattern portions 121 and 122 may be approximately 0.5 mm, and the length L of the plurality of adjustment pattern portions 121 and 122 may be 5 mm or between 4 mm and 6 mm. The diameter D of the semicircular plate portion 110 may be 8 mm.

According to an embodiment, the semicircular plate portion 110 may include a groove 111 extending from the center of the semicircular plate portion 110, and the groove 111 may extend perpendicularly from the straight line of the semicircular plate portion 110. The groove 111 may be positioned on the same straight line as the CPW line 130. The width of the groove 111 and the CPW line 130 may be the same or different. The groove 111 may extend in the same direction as the CPW line 130.

The length of the groove 111 may be smaller than the radius of the semicircular plate portion 110 and may be smaller than the length of the plurality of adjustment pattern portions 121 and 122. The length of the CPW line 130 may be smaller than the length of the plurality of adjustment pattern portions 121 and 122.

According to an embodiment, the plurality of adjustment pattern portions 121 and 122 extend perpendicularly from the straight line of the semicircular plate portion 110, the CPW line 130 may at least partially arranged in at least part between the plurality of adjustment pattern portions 121 and 122, and at least parts of the plurality of adjustment pattern portions 121 and 122 and the CPW line 130 may be parallel.

At least some of the above-described components of the antenna may change in size depending on the size of the UWB chip/component/circuit 140. The length C of the UWB chip/component/circuit 140 may be 10.00 mm. The length B excluding the UWB chip/component/circuit 140 in the antenna may be 5.50 mm. The width of the UWB chip/component/circuit 140 may be the same as the width A of the antenna and may be 10.00 mm.

According to an embodiment, the antenna may have a width A of 10.00 mm and a length B+C of 15.50 mm. According to an embodiment, the antenna may be larger than 8 mm in width and 5.50 mm in length.

The antenna has the effect of adjusting the resonance frequency according to the ground GND condition of the set or module by adding the adjustment pattern portions 121 and 122 to the end of the antenna.

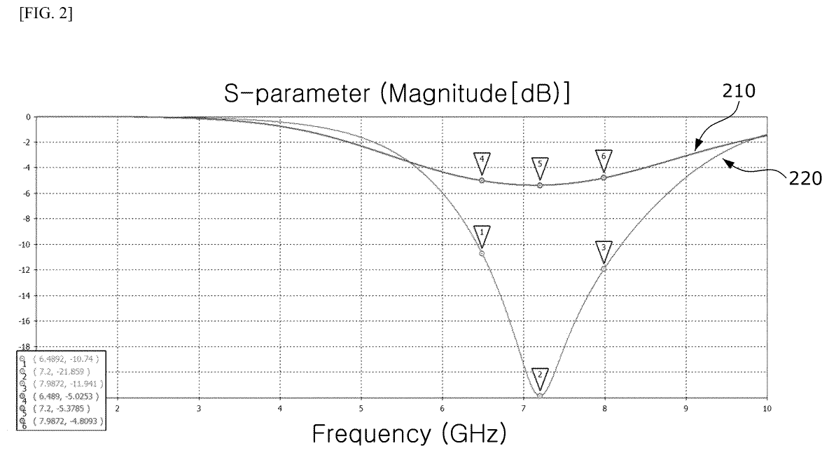

FIG. 2 is a graph representing the bandwidth of the CPW line according to an embodiment.

With reference to FIG. 2, it can be observed that the graph represents the S-parameters (Magnitude in dB), and the antenna may primarily operate within the frequency range of 3.1 to 10.6 GHz. According to an embodiment, an antenna with a CPW line (S1, 1_with CPW) denoted by reference number 220 may exhibit improved performance compared to an antenna without a CPW line (S1, 1_without CPW) denoted by reference number 210.

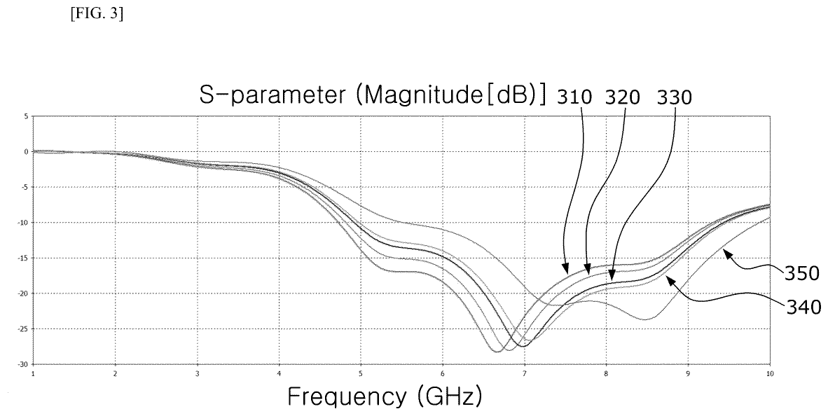

FIG. 3 is a graph representing the resonance variation of an antenna according to an embodiment.

With reference to FIG. 3, it can be observed that the graph represents the S-parameters (Magnitude in dB). When the length of adjustment pattern portions of the antenna is 4.0 mm as denoted by reference number 310, 4.5 mm by 320, 5.0 mm by 330, 5.5 mm by 340, and 6.0 mm by 350, each can be represented by a different curve.

According to an embodiment, it is possible to adjust the resonance frequency of the antenna by varying the length of the adjustment pattern portions of the antenna.

The length of the adjustment pattern portions may range from approximately 4 mm to 6 mm (4 mm, 4.5 mm, 5 mm, 5.5 mm, and 6 mm), with the length optimized for a frequency of 7 GHz being 5 mm. As the length of the adjustment pattern portions increases, the antenna may have lower frequencies. As the length of the adjustment pattern portions decreases, the antenna may have higher frequencies.

This antenna can be versatilely utilized due to the possibility of adjusting the resonant frequency based on the ground (GND) condition of the set or module that is completed by adding the adjustment pattern portions to the antenna body or end.

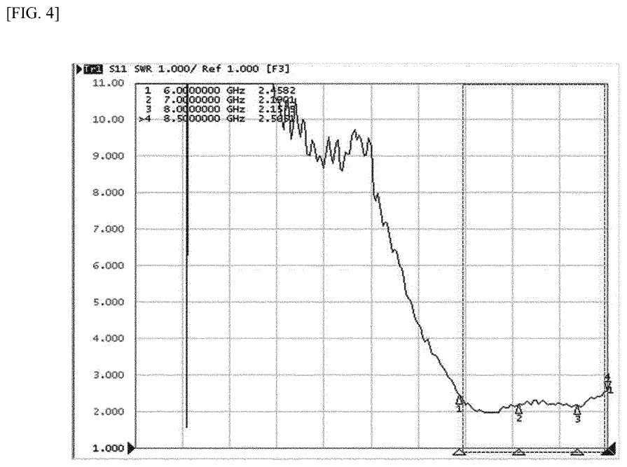

FIG. 4 is a graph illustrating the resonance characteristics of an antenna according to an embodiment.

With reference to FIG. 4, the antenna including the CPW line, according to an embodiment, is capable of broadband matching, thereby covering most of the UWB bands with a broadband matching range of 6 to 8.5 GHz.

Furthermore, the antenna including the adjustment pattern portions, according to an embodiment, offers versatility for diverse set environments or modules of varying sizes and can shift the resonance frequency by 1.5 GHz.

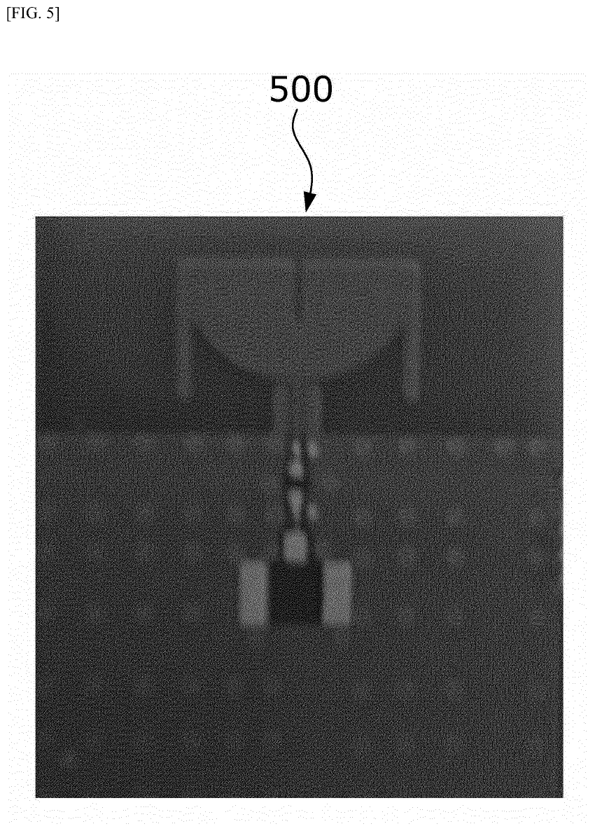

FIG. 5 is a diagram illustrating an antenna module according to an embodiment.

With reference to FIG. 5, the antenna module 500 may include at least some of the components of the antenna described above.

According to an embodiment, the antenna module 500 may include a semicircular plate portion and a plurality of adjustment pattern portions extending from the both ends of the semicircular plate portion.

According to an embodiment, the antenna module 500 may further include a coplanar waveguide (CPW) line extending perpendicularly from at least part of the straight line of the semicircular plate portion.

According to an embodiment, the plurality of adjustment pattern portions may extend from both ends of the straight line of the semicircular plate portion with a constant width and the same length.

According to an embodiment, the semicircular plate portion includes a groove extending from the center of the semicircular plate portion, with the groove extending perpendicularly from the straight line of the semicircular plate portion.

According to an embodiment, the plurality of adjustment pattern portions extend perpendicularly from the straight line of the semicircular plate portion, the CPW line may at least partially arranged in at least part between the plurality of adjustment pattern portions, and at least parts of the plurality of adjustment pattern portions and the CPW line may be parallel.

The antenna module 500 may be utilized in household appliances such as TVs and may also be suitable for small appliances.

Although the description has been made of the embodiments, it is only given as an example and does not limit the present invention, and those skilled in the art to which the present invention belongs will know that various modifications and applications not illustrated above are possible without departing from the essential characteristics of the present embodiment. For example, each component specifically illustrated in the embodiment may be modified and implemented. And differences related to these modifications and applications should be construed as being included in the scope of the present invention as defined in the appended claims.

1-7. (canceled)

8. An antenna comprising:
a semicircular plate portion; and
a plurality of adjustment pattern portions extending from ends of the semicircular plate portion.

9. The antenna of claim 8, further comprising a coplanar waveguide (CPW) line extending from at least part of the semicircular plate portion, perpendicular to a straight line of the semicircular plate portion.

10. The antenna of claim 8, wherein the plurality of adjustment pattern portions extend from both ends of a straight line of the semicircular plate portion with a constant width and the same length.

11. The antenna of claim 9, wherein the semicircular plate portion comprises a groove extending from the center of the semicircular plate portion, perpendicular to the straight line of the semicircular plate portion.

12. The antenna of claim 9, wherein the plurality of adjustment pattern portions extend perpendicular to the straight line of the semicircular plate portion, the CPW line is at least partly arranged in at least part between the plurality of adjustment pattern portions, and at least parts of the plurality of adjustment pattern portions and the CPW line are parallel.

13. The antenna of claim 8, wherein the plurality of adjustment pattern portions are formed in the shapes of wings extending from the semicircular plate portion.

14. The antenna of claim 8, wherein the plurality of adjustment pattern portions comprise a first adjustment pattern portion and a second adjustment pattern portion that are symmetrically arranged and identical in length and width.

15. The antenna of claim 8, wherein the semicircular plate portion and the plurality of the adjustment pattern portions are arranged on the same plane.

16. The antenna of claim 11, wherein the groove is arranged on the same straight line as the CPW line.

17. An antenna module comprising:
a semicircular plate portion; and
a plurality of adjustment pattern portions extending from ends of the semicircular plate portion.

18. The antenna module of claim 17, further comprising a coplanar waveguide (CPW) line extending from at least part of the semicircular plate portion, perpendicular to a straight line of the semicircular plate portion.

19. The antenna module of claim 17, wherein the plurality of adjustment pattern portions are formed in the shapes of wings extending from the semicircular plate portion.

20. The antenna module of claim 17, wherein the plurality of adjustment pattern portions comprise a first adjustment pattern portion and a second adjustment pattern portion that are symmetrically arranged and identical in length and width.

21. The antenna module of claim 17, wherein the semicircular plate portion and the plurality of the adjustment pattern portions are arranged on the same plane.

22. The antenna module of claim 18, wherein the semicircular plate portion comprises a groove extending from the center of the semicircular plate portion, the groove extending perpendicular to the straight line of the semicircular plate portion and arranged on the same straight line as the CPW line.
